(19) United States
(12) Patent Application Publication
(10) Pub. No.: US 2026/0030926 A1
(43) Pub. Date: Jan. 29, 2026

(54) SYSTEM AND METHOD FOR DETERMINING ANCESTRAL INFORMATION OF A USER USING ARTIFICIAL INTELLIGENCE (AI) TECHNIQUE

(71) Applicant: Illumination Station Press, LLC, Center Cross, VA (US)

(72) Inventor: Amy Gillespie Dougherty, Center Cross, VA (US)

(73) Assignee: Illumination Station Press, LLC, Center Cross, VA (US)

(21) Appl. No.: 18/780,511

(22) Filed: Jul. 23, 2024

(51) Int. Cl. G06V 40/18; G06V 10/75; G06V 10/94

(52) U.S. Cl. CPC G06V 40/197; G06V 10/751; G06V 10/945; G06V 40/193

(57) ABSTRACT

A system and method for determining ancestral information of a user using an artificial intelligence (AI) technique is disclosed. The method comprises receiving, via the at least one processor, one or more images of eyes of a user from one or more sources; extracting, via the at least one processor, one or more characteristics from the one or more images of the eyes of the user, using an artificial intelligence (AI) model; comparing, via the at least one processor, the extracted one or more characteristics from the one or more images with a historical data, using the AI model; and determining, via the at least one processor, ancestral information of the user based at least on the comparison, using the AI model. The ancestral information corresponds to data and knowledge related to predecessors or originators of the user.

### FIELD OF THE DISCLOSURE

The disclosure relates to an ancestral information determination. More particularly, the disclosure relates to a system and method for determining ancestral information of a user using an artificial intelligence (AI) technique.

### BACKGROUND OF THE DISCLOSURE

The subject matter discussed in this background section should not be assumed to be prior art merely as a result of its mention herein. Similarly, any problems mentioned in this background section or associated with the subject matter of this background section should not be assumed to have been previously recognized in the prior art. The subject matter as disclosed in this background section merely represents different approaches related to ancestral information determination, wherein such system and method themselves may also correspond to implementations of the claimed technology and disclosure.

Ancestral information encompasses a rich tapestry of data about an individual's lineage, heritage, and familial history. The ancestral information is a multifaceted concept that includes genealogical records such as birth, marriage, and death certificates, alongside historical documents like census records and immigration papers. Additionally, the ancestral information involves genetic data that reveals ethnic origins, inherited traits, and potential health predispositions. Further, cultural and historical contexts offer insights into the regions of ancestors, their occupations, or traditions. Further, oral histories, passed down through generations, add a personal and narrative dimension to understanding one's roots. Such ancestral information form a comprehensive picture of one's ancestry, connecting the past to the present and enriching one's sense of identity and heritage.

Prior art, for various aspects contained there within, relevant to this disclosure includes U.S. Pat. Publication No. US2023352115A1 to Girshick; U.S. Pat. Publication No. US2024078839A1 to Andrews, and E.P. Pat. Publication No. EP4220128A1 to Leube. In each of these prior arts, different techniques are disclosed for predicting traits of a person, discloses about capturing images of eyes of the person for different applications. This is not an ideal solution to the problem of determining ancestral information of the person using an artificial intelligence (AI) technique.

In particular, reference '115 to Girshick discloses techniques for predicting a trait of an individual and identifying a set of enriched record collections of a genetic community. To predict a trait of the individual, DNA features and non-DNA features of the individual are accessed to generate a feature vector that is inputted into a machine learning model. The machine learning model generates a prediction of the trait. The prediction may be based on an inheritance prediction and/or a community prediction. To identify a set of enriched record collections, individuals belonging to a genetic community are identified and a set of candidate record collections are accessed. Further, a community count and a background count are determined for each candidate record collection. The set of enriched record collections are identified based on a comparison of the community count and the background count. The genetic community may be annotated using the set of enriched record collections. However, unlike the subject matter of the present disclosure, Girshick does not disclose about determining information output which includes basics of origin, brain hemisphere orientation (creative, analytical, or instinctual), and indicators of personality shifts in youth to generate ancestral eye reading. Further, Girshick also does not disclose about a capability to identify unresolved traumas by using the indicators in the eye to improve awareness and self-esteem.

Reference '839 to Andrews discloses a diverse dataset of human images that can be created by collecting a plurality of images from a plurality of diverse people. A first graphical user interface requires a user to provide subject data, instrument data and environment data as metadata for each of the plurality of images. A second graphical user interface requires a user to form a bounding box about a face of a subject in each of the plurality of images. A third graphical user interface requires annotators to provide annotations for each of the plurality of images. The dataset may be used for training or evaluating machine learning or artificial intelligence systems, such as systems for body and face detection, body and face landmark detection, body and face parsing, face alignment, face recognition, face verification, image editing and image synthesis. However, unlike the subject matter of the present disclosure and similar to reference '115, Andrews also does not disclose about determining information output which includes basics of origin, brain hemisphere orientation (creative, analytical, or instinctual), and indicators of personality shifts in youth to generate ancestral eye reading. Further, Andrews also does not disclose about a capability to identify unresolved traumas by using the indicators in the eye to improve awareness and self-esteem.

Reference '282 to Leube discloses a computer-implemented method, a computer program, and an apparatus for determining at least one lens shape for producing at least one optical lens for at least one eye of a person as well as to use of a personal computer. Herein, the method comprises the following steps: a) receiving first information about at least one refractive error of at least one eye of a person and second information related to the person; b) determining at least one lens shape for at least one optical lens for the at least one eye of the person designated for correcting the at least one refractive error of the at least one eye of the person using the first information, wherein at least one lens shape parameter of the at least one optical lens is adapted to the second information related to the person, wherein at least one piece of the second information is determined from data recorded by at least one electronic component of the at least one personal computer used by the person. As the present disclosure relies on recording the second information using a personal computer, the recording may be performed anywhere and by any person. However, Leube does not disclose about determining information output which includes basics of origin, brain hemisphere orientation (creative, analytical, or instinctual), and indicators of personality shifts in youth to generate ancestral eye reading. Further, Andrews also does not disclose about a capability to identify unresolved traumas by using the indicators in the eye to improve awareness and self-esteem.

Further, none of the identified references disclose about generating ancestral eye reading by using the determined characteristics. Also, none of the references disclose about using information such as brain hemisphere orientation (creative, analytical, or instinctual), and indicators of personality shifts in youth to generate ancestral eye reading. The references also fail to disclose identifying unresolved traumas by using the indicators in the eye in order to improve awareness and self-esteem.

Given the deficiencies of the prior art, therefore the need remains for an effective and a user friendly platform that is configured to determine the ancestral information of the user based on multiple images of eyes of the user along with the identification of different aberrations of the user such as traumas, illness etc.

### SUMMARY OF THE DISCLOSURE

According to embodiments illustrated herein, a novel, simple and interactive system and method for determining ancestral information of a user using an artificial intelligence (AI) technique is disclosed. The method comprises receiving, via at least one processor, one or more images of eyes of a user from one or more sources. The one or more images correspond to a left eye image and a right eye image of the user. Further, the method comprises extracting, via the at least one processor, one or more characteristics from the one or more images of the eyes of the user, using an artificial intelligence (AI) model. The one or more characteristics correspond to distinct and identifiable features that describe structure, function, and appearance of the left eye and the right eye of the user. Further, the method comprises comparing, via the at least one processor, the extracted one or more characteristics from the one or more images with a historical data, using the AI model. Thereafter, the method comprises determining, via the at least one processor, ancestral information of the user based at least on the comparison, using the AI model. The ancestral information corresponds to data and knowledge related to predecessors or originators of the user.

In some embodiments, the method further comprises identifying, via the at least one processor, one or more aberrations associated with the user, based at least on the determined ancestral information, using the AI model. The one or more aberrations comprise at least one of unresolved traumas, energetic and operating process of the user, and a way of interaction of the user with other users.

In some embodiments, the ancestral information comprises at least one of basis of origin of the user, brain hemisphere orientation, one or more indicators of personality shifts within the user, vocational gifts, or ancestral images. The one or more indicators of personality shifts within the user correspond to one or more features of the eyes that are responsible for determining at least one of emotional, physical, and psychological state of the user. In some embodiments, the one or more indicators comprise at least one of postage stamps, cross fiber, channels, fiber separation, or freckle.

In some embodiments, the historical data corresponds to a repository of one or more sample images of eyes of users having the one or more characteristics collected over a predefined time period. The predefined time period corresponds to hours, days, months, or years.

In some embodiments, the method further comprises training, via the at least one processor, the AI model based at least on the repository of the one or more sample images of the eyes of the users for determining the ancestral information of the user.

In some embodiments, the method further comprises generating, via the at least one processor, one or more quiz questions using the AI model, to determine an intuitive type of the user. In some embodiments, the intuitive type corresponds to an attribute of the user, where the user relies on intuition during a decision-making process.

In some embodiments, the method further comprises creating, via the at least one processor, one or more overlay regions of the eyes of the user, using the AI model. The one or more overlay regions of the eyes of the user correspond to one or more regions of iris, pupil, rings, or sclera. Thereafter, the method comprises receiving, via the at least one processor, a selection of at least one overlay region from the one or more overlay regions, from the user, to determine the ancestral information associated to the selected at least one overlay region of the user.

In some embodiments, the one or more characteristics comprises at least one of color of the left eye and the right eye, color of iris of the left eye and the right eye, autonomic nerve wreath (ANW), pupil size, sclera, achievement rings, or iris patterns.

In some embodiments, the method further comprises displaying, via the at least one processor, the determined ancestral information of the user and the one or more aberrations, to the user. In some embodiments, the one or more sources comprise at least one of an image capturing device that is configured to capture the one or more images of the eyes of the user.

In another example embodiment, a system for determining ancestral information of a user using an artificial intelligence (AI) technique is disclosed. The system comprises a memory and at least one processor communicatively coupled to the memory. The at least one processor is configured to receive one or more images of eyes of a user from one or more sources. The one or more images correspond to a left eye image and a right eye image of the user. Further, the at least one processor is configured to extract one or more characteristics from the one or more images of the eyes of the user, using an artificial intelligence (AI) model. The one or more characteristics correspond to distinct and identifiable features that describe structure, function, and appearance of the left eye and the right eye of the user. Further, the at least one processor is configured to compare the extracted one or more characteristics from the one or more images with a historical data, using the AI model. Thereafter, the at least one processor is configured to, determine ancestral information of the user based at least on the comparison, using the AI model. The ancestral information corresponds to data and knowledge related to predecessors or originators of the user.

In yet another example embodiment, a non-transitory machine-readable information storage medium for determining ancestral information of a user using an artificial intelligence (AI) technique is disclosed. The non-transitory machine-readable information storage medium comprises one or more instructions which when executed by at least one processor cause the at least one processor to receive one or more images of eyes of a user from one or more sources, wherein the one or more images correspond to a left eye image and a right eye image of the user; extract one or more characteristics from the one or more images of the eyes of the user, using an artificial intelligence (AI) model, wherein the one or more characteristics correspond to distinct and identifiable features that describe structure, function, and appearance of the left eye and the right eye of the user; compare the extracted one or more characteristics from the one or more images with a historical data, using the AI model; and determine ancestral information of the user based at least on the comparison, using the AI model, wherein the ancestral information corresponds to data and knowledge related to predecessors or originators of the user.

### BRIEF DESCRIPTION OF THE DRAWINGS

While the specification concludes with claims particularly pointing out and distinctly claiming particular embodiments of the present disclosure, various embodiments of the present disclosure can be more readily understood and appreciated from the following descriptions of various embodiments of the present disclosure when read in conjunction with the accompanying drawings, in which:

FIG. 1 illustrates a network diagram of a system for determining ancestral information of a user using an artificial intelligence (AI) technique, according to an example embodiment of the present disclosure;

FIG. 2 illustrates a block diagram of a server, according to the example embodiment of the present disclosure;

FIG. 3 illustrates a table depicting a memory, according to the example embodiment of the present disclosure;

FIGS. 4-10 illustrate a user interface (UI) depicting startup pages, according to the example embodiment of the present disclosure;

FIGS. 11-12 illustrate the UI depicting image upload page, according to the example embodiment of the present disclosure;

FIG. 13 illustrates the UI depicting a quiz page, according to the example embodiment of the present disclosure; and

FIG. 14 illustrates a flowchart showing a method for determining the ancestral information of the user using the AI technique, according to the example embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items or meant to be limited to only the listed item or items.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems, and methods are now described.

Embodiments of the present disclosure will be described more fully hereinafter with reference to the accompanying drawings in which like numerals represent like elements throughout the several figures, and in which example embodiments are shown. Embodiments of the present disclosure may, however, be embodied in alternative forms and should not be construed as being limited to the embodiments set forth herein. The examples set forth herein are non-limiting examples and are merely examples among other possible examples.

In some embodiments, the disclosure relates to a system and a method for determining ancestral information of a user using an artificial intelligence (AI) technique. The disclosure enables psychic ancestral eye reading for the purpose of ancestral discovery and self-awareness of a user. Further, the disclosure provides the user to follow a guided process for taking and uploading their own eye photos. Further, the disclosure is configured to analyse different eye characteristics such as eye colour, colour of iris rings, autonomic nerve wreath (ANW), etc. Further, the disclosure enables one to identify unresolved traumas by using indicators of personality shifts within the user correspond to one or more features of the eyes, for improving awareness and self-esteem.

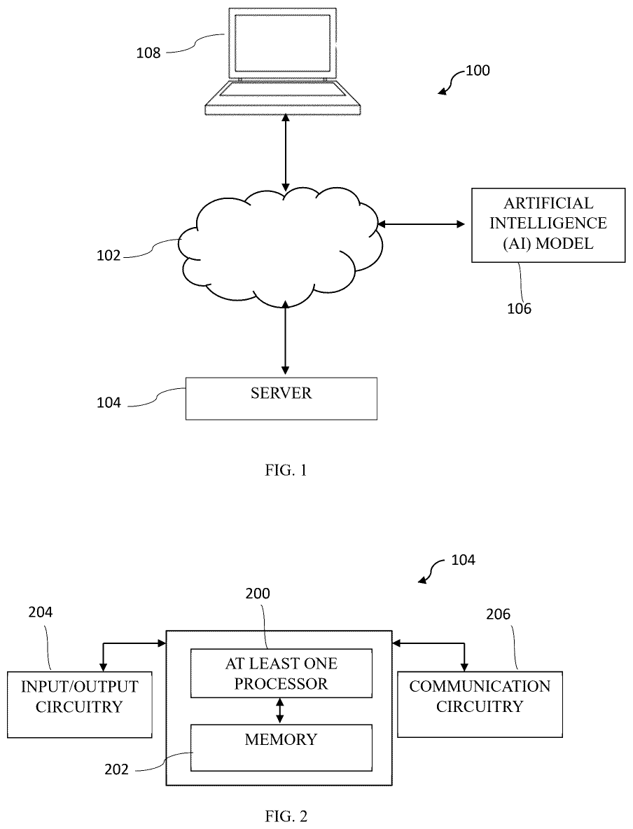

FIG. 1 illustrates a network diagram of a system 100 for determining ancestral information of a user using an artificial intelligence (AI) technique, according to example embodiment of the present disclosure. The system 100 may comprise a network 102 communicatively coupled to a server 104, an artificial intelligence (AI) model 106, and a user device 108.

In some embodiments, the network 102 may be a communication network such as internet or a cloud network, that may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the system 100 may connect to the network 102 in accordance with various wired and wireless communication protocols such as Transmission Control Protocol and Internet Protocol (TCP/IP), User Datagram Protocol (UDP), and 2G, 3G, or 4G communication protocols.

Further, the system 100 may comprise the server 104. In some embodiments, the server 104 may be a computer or software module that is configured to provide centralized resources, data, or services to the user device 108 operated by the user. The server 104 may be configured to handle and manage one or more computational tasks and data processing within the system 100. In some embodiments, the server 104 may include storage systems, such as hard drives or storage arrays, to store and manage large volumes of data and information accessible to network users. In some embodiments, the server 104 may further provide centralized control and management capabilities, allowing network administrators to configure, monitor, and maintain network resources, security settings, and user access permissions from a single location.

In some embodiments, the server 104 may be configured to receive one or more images of eyes of the user from one or more sources. The one or more sources may comprise at least one of an image capturing device (not shown) that is configured to capture the one or more images of the eyes of the user and a memory (not shown). For example, the image capturing device may be mobile phones, digital cameras etc. For example, the memory may be cloud storage, and a local gallery of the image capturing device etc. Further, the one or more images may correspond to a left eye image and a right eye image of the user.

In some embodiments, the server 104 may further be configured to extract one or more characteristics from the one or more images of the eyes of the user, using the AI model 106. In some embodiments, the one or more characteristics may correspond to distinct and identifiable features that describe structure, function, and appearance of the left eye and the right eye of the user. In some embodiments, the one or more characteristics may comprise at least one of color of the left eye and the right eye, color of iris of the left eye and the right eye, autonomic nerve wreath (ANW), pupil size, sclera, achievement rings, or iris patterns.

In some embodiments, the server 104 may further be configured to compare the extracted one or more characteristics from the one or more images with a historical data, using the AI model 106. In some embodiments, the historical data may correspond to a repository of one or more sample images of eyes of users having the one or more characteristics collected over a predefined time period. In some embodiments, the predefined time period corresponds to hours, days, months, or years.

In some embodiments, the server 104 may further be configured to determine ancestral information of the user based at least on the comparison between the extracted one or more characteristics from the one or more images with the historical data, using the AI model 106. The ancestral information corresponds to data and knowledge related to predecessors or originators of the user. In some embodiments, the ancestral information may involve epigenetic data that reveals ethnic origins and inherited traits. In this instance, if an individual seeks or is concerned regarding any aspect of their eye health, then the individual needs to consult a medical professional. In some embodiments, the ancestral information comprises at least one of basis of origin of the user, brain hemisphere orientation, one or more indicators of personality shifts within the user, vocational gifts, or ancestral images. In some embodiments, the one or more indicators of personality shifts within the user correspond to one or more features of the eyes that are responsible for determining at least one of emotional, physical, and psychological state of the user. Further, the one or more indicators may comprise at least one of postage stamps, cross fiber, channels, fiber separation, or freckle.

In some embodiments, the server 104 may be configured to identify one or more aberrations associated with the user based at least on the determined ancestral information, using the AI model 106. In some embodiments, the one or more aberrations may comprise at least one of unresolved traumas, energetic and operating process of the user, and a way of interaction of the user with other users. In some embodiments, the server 104 may be configured to train the AI model 106 based at least on the repository of the one or more sample images of the eyes of the users for determining the ancestral information of the user.

In some embodiments, the server 104 may be configured to generate one or more quiz questions using the AI model 106, to determine an intuitive type of the user. The intuitive type corresponds to an attribute of the user, where the user relies on intuition during a decision- making process. In some embodiments, the server 104 may be configured to display the determined ancestral information of the user and the one or more aberrations to the user, using the user device 108. In some embodiments, the server 104 may be configured to create one or more overlay regions of the eyes of the user, using the AI model 106. The one or more overlay regions of the eyes of the user correspond to one or more regions of iris, pupil, rings, or sclera. Further, the server 104 may be configured to receive selection of at least one overlay region from the one or more overlay regions, from the user, to determine the ancestral information associated to the selected at least one overlay region of the user.

In some embodiments, the AI model 106 may be a computational construct designed to simulate human intelligence and perform tasks that typically require human cognition. The AI model 106 may be created through machine learning and other AI techniques, where the AI model 106 learns patterns, make predictions, and provide insights to the user. In some embodiments, the AI model 106 may be trained based at least on the repository of the one or more sample images of the eyes of the users. Based upon the training, the AI model 106 may be able to analyze the one or more characteristics extracted from the left eye and the right eye of the user for determining the ancestral information of the user. Further, the AI model 106 may be capable of identifying and predicting the one or more aberrations based on the determined ancestral information. The one or more aberrations may comprise at least one of unresolved traumas, energetic and operating process of the user, and a way of interaction of the user with other users.

In some embodiments, the user device 108 comprises a graphical user interface (GUI) that provides a user-friendly platform for the user to determine the ancestral information using the one or more images of the left eye and the right eye and interact with the system 100. The GUI may be web-based, accessed through a browser, or through a dedicated software application installed on desktop computers, laptops, tablets, or smartphone. The user device 108 may be equipped by the user or other service professionals responsible for determining and accessing the ancestral information. In some embodiments, the user device 108 may include personal computers such as desktop computers, laptop computers, tablets, smartphones, or mobile devices.

It will be apparent to one skilled in the art that above-mentioned components of the system 100 have been provided only for illustration purposes, without departing from the scope of the disclosure.

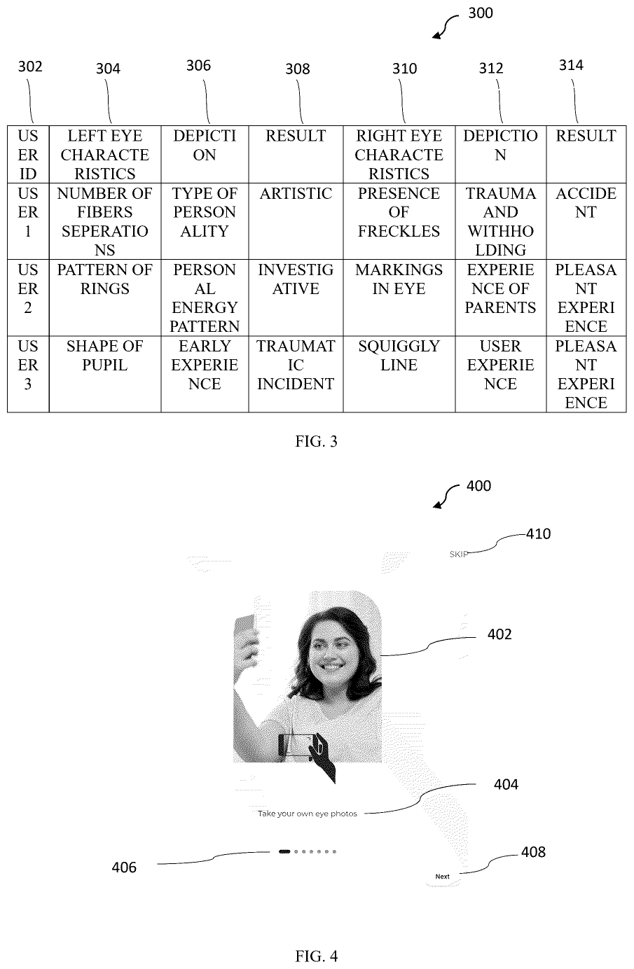

FIG. 2 illustrates a block diagram of the server 104, according to an example embodiment of the present disclosure. FIG. 3 illustrates a table 300 depicting a memory 202, according to an example embodiment of the present disclosure. FIGS. 2-3 are described in conjunction with FIG. 1. In some embodiments, the server 104 may comprise at least one processor 200, a memory 202, an input/output circuitry 204, and a communication circuitry 206.

In some embodiments, the at least one processor 200 may correspond to a controller for executing one or more operations within the server 104. The at least one processor 200 may be communicatively coupled to the memory 202. In some embodiments, the at least one processor 200 may be configured to receive the one or more images of the user from the user device 108. In some embodiments, the user device 108 may be laptop, smartphone, desktop etc. In one example, a user “Alex” uses his mobile phone to capture a left eye image and a right eye image of the user. After capturing the left eye image and the right eye image of the user, the images are uploaded by the at least one processor 200 on an application running on the mobile device.

Further, the at least one processor 200 may be configured to extract one or more characteristics from the one or more images of the eyes of the user, using an artificial intelligence (AI) model. The one or more characteristics may correspond to distinct and identifiable features that describe structure, function, and appearance of the left eye and the right eye of the user. In one example, the at least one processor 200, using the AI model 106, extracts characteristics including color of the left eye and the right eye, color of iris of the left eye and the right eye, autonomic nerve wreath (ANW), pupil size, sclera, achievement rings, or iris patterns. In one example, the colour of the iris is determined as Hazel. Further, the pupil size is 5-6 millimetres in diameter.

In some embodiments, the at least one processor 200 may be configured to extract the one or more characteristics from both the left eye image and the right eye image since both the left eye and the right eye enables the at least one processor 200 to extract different characteristics. In one example, the right eye of the user represents identity & arbitrary control, masculine influences and energies, left brain, legal & ownership, analytics and doing, men in life, and inner masculine. Similarly, the left eye represents creativity & religion, feminine influences and energies, right brain, interpretive sports & dance, emotions & the arts, the women in life, and inner-feminine.

In one example, a mark in the right eye and in the area of 6:00 may represent a gift for writing (with open fibers) of the user. The mark represents technical writing or creating training manuals and guides. The 6:00 represents position is at the bottom, directly below the center of the pupil. In another example, in the left eye, that same 6:00 fiber openings are more likely to represent creative writing, music, stories, spiritual, or automatic writing.

In some embodiments, the at least one processor 200 may further be configured to compare the extracted one or more characteristics from the one or more images with the historical data, using the AI model 106. In some embodiments, the historical data corresponds to a repository of one or more sample images of eyes of users having the one or more characteristics collected over a predefined time period. In some embodiments, the predefined time period corresponds to hours, days, months, or years. In one example, the at least one processor 200 may be configured to use one or more sample of images of 200 people stored in last 300 days.

In some embodiments, the at least one processor 200 may further be configured to determine ancestral information of the user based at least on the comparison of the extracted one or more characteristics from the one or more images and the historical data, using the AI model 106. The ancestral information corresponds to data and knowledge related to predecessors or originators of the user. In some embodiments, the ancestral information comprises at least one of basis of origin of the user, brain hemisphere orientation, one or more indicators of personality shifts within the user, vocational gifts, or ancestral images. The one or more indicators of personality shifts within the user correspond to one or more features of the eyes that are responsible for determining at least one of emotional, physical, and psychological state of the user. The one or more indicators comprises at least one of postage stamps, cross fiber, channels, fiber separation, or freckle.

In some embodiments, the extracted one or more characteristics may be stored within the memory 202 as shown by the table 300. The table 300 may have columns of user ID 302, left eye characteristics 304, depiction of the left eye characteristics 306, result of the left eye characteristics 308, right eye characteristics 310, depiction of the right eye characteristics 312, and result of the right eye characteristics 314. In one example, a basic structure of the eye determines if the user is more analytical or more creative (i.e., operating from right brain or left brain). Further, number of fiber separations and how open or tight the fiber separations are lead to what kind of personality structure the user has, as shown in the table 300. Further, the rings in the eyes represent about the user's personal energy pattern and how the user interacts with other users. Further, openings in squiggly line tells about repeat patterns that the user may be experiencing in a lifetime. Further, the shape of the pupil tells about the user's earliest experiences in home environment. The presence of freckles and shape, depth, and thickness of the fiber separations reveal some of the user's inherent talents, as well as areas of trauma and withholding. In one example, one or more markings in the eye further reveal user's parents experience of user's time in-utero, particularly if there were any traumatic moments during pregnancy. It may be noted that the above-mentioned characteristics have been provided only for illustration purposes. In some embodiments, the present disclosure reveals user's level of introversion or extroversion, without departing from the scope of the disclosure.

In some embodiments, the AI model 106 may be configured to use the one or more images to extract characteristics through a process involving several key steps, typically employing techniques from computer vision and machine learning. The techniques may include image processing, feature extraction, convolution neural networks (CNNs), and feature representation. The at least one processor 200, using the AI model 106, may be configured to extract one or more characteristics from the one or more images by identifying and selecting relevant information from one or more images to represent in a more simplified and meaningful way. In some embodiments, the at least one processor 200, using the AI model 106, is configured to apply filters to detect patterns like edges and textures from the eyes of the user, while subsequent pooling layers reduce spatial dimensions while preserving relevant information. Through training on large datasets with labelled examples, the at least one processor 200 may be configured to optimize the AI model 106 to extract discriminative features that facilitate accurate image understanding for determining the ancestral information.

In some embodiments, the at least one processor 200 may be configured to identify one or more aberrations associated with the user based at least on the determined ancestral information, using the AI model 106. In some embodiments, the one or more aberrations may comprise at least one of unresolved traumas, energetic and operating process of the user, and a way of interaction of the user with other users. In one example, a crease that goes all the way to the pupil tends to show the most traumatic experiences of the user's ancestral line and may be playing out in current life as a repeat pattern. In another example, a freckle in a left eye at 5:45 and a freckle in a right eye at 06:15 reveal resistance to writing or signature agreements, or a pattern or traumas that have stemmed from something written, such as love note that is found and reveals user's ancestors infidelity, or patterns of traumas over signing ones name to documents, bank notes etc.

In some embodiments, the at least one processor 200 is configured to train the AI model 106 based at least on the repository of the one or more sample images of the eyes of the users for determining the ancestral information of the user. In some embodiments, the at least one processor 200 may further be configured to generate one or more quiz questions using the AI model 106, to determine an intuitive type of the user. The intuitive type corresponds to an attribute of the user, where the user relies on intuition during a decision-making process. In one example, the quiz question may include “what's your ancestral imprint and gifts?”, “what's your hidden talent?” etc.

In some embodiments, the at least one processor 200 is configured to display the determined ancestral information of the user and the one or more aberrations, to the user on the user device 108. In some embodiments, the at least one processor 200 may be configured to create one or more overlay regions of the eyes of the user, using the AI model 106. The one or more overlay regions of the eyes of the user correspond to one or more regions of iris, pupil, rings, or sclera. Further, the at least one processor 200 may be configured to display the one or more overlay regions of the eyes to the user. Thereafter, the at least one processor 200 may be configured to receive selection of at least one overlay region from the one or more overlay regions, from the user, to determine the ancestral information associated to the selected at least one overlay region of the user.

In some embodiments, the one or more overlay regions comprises specific areas or zones within an image from the one or more images, where additional information, graphics, or visual elements of one or more overlay regions of the left eye and the right eye are superimposed or overlaid. In some embodiments, the one or more overlay regions are defined within the AI model 106 to enhance the usability or functionality of the one or more images. As described above, the one or more overlay regions may comprise at least, pupil, iris, sclera etc. In one example, the one or more overlay regions may be represented with varying brightness intensities for showing various details of the one or more overlay regions.

Further, based on different brightness adjustments, the user may be able to select one of the overlay regions from the one or more overlay regions to determine the ancestral information associated to the selected at least one overlay region of the user. In another example, the at least one processor 200 may further be configured to use augmented reality (AR) elements comprising at least, virtual objects, annotations, or information overlays that may be added to the live view of the selected at least one overlay region of the user, enhancing interactive and augmented experiences.

In some embodiments, the server 104 may further comprise the input/output circuitry 204. The input/output circuitry 204 may enable the user to communicate or interface with the system 100, via the user device 108. The user device 108 may include N number of user devices. In some embodiments, the input/output circuitry 204 may act as a medium to transmit input from the interface to and from the system 100. In some embodiments, the input/output circuitry 204 may refer to the hardware and software components that facilitate the data related to the one or more images related to left eye image and right eye image, between the user device 108 and the system 100. In one example, the system 100 may include a graphical user interface (GUI) (not shown) as an input circuitry to allow the users to input data. The input/output circuitry 204 may include various input devices such as keyboards, barcode scanners, GUI for the users to provide data and various output devices such as displays, printers for the one or more users to receive data. In another example, the input/output circuitry 204 may include various output circuitry such as a display. In one example, the input/output circuitry 204 may interface with the user device 108 to receive the one or more images of the eyes of the user.

In some embodiments, the server 104 may further comprise the communication circuitry 206. The communication circuitry 206 may allow the server 104 to exchange data or information with other systems or apparatuses. Further, the communication circuitry 206 may include network interfaces, protocols, and software modules responsible for sending and receiving data or information. In some embodiments, the communication circuitry 206 may include Ethernet ports, Wi-Fi adapters, or communication protocols like HTTP or MQTT for connecting with other systems. The communication circuitry 206 may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry 206 may allow the system 100 to stay up-to-date. In some embodiments, the communication circuitry 206 may enable seamless communication between the user device 108.

It will be apparent to one skilled in the art the above-mentioned components of the server 104 have been provided only for illustration purposes, without departing from the scope of the disclosure.

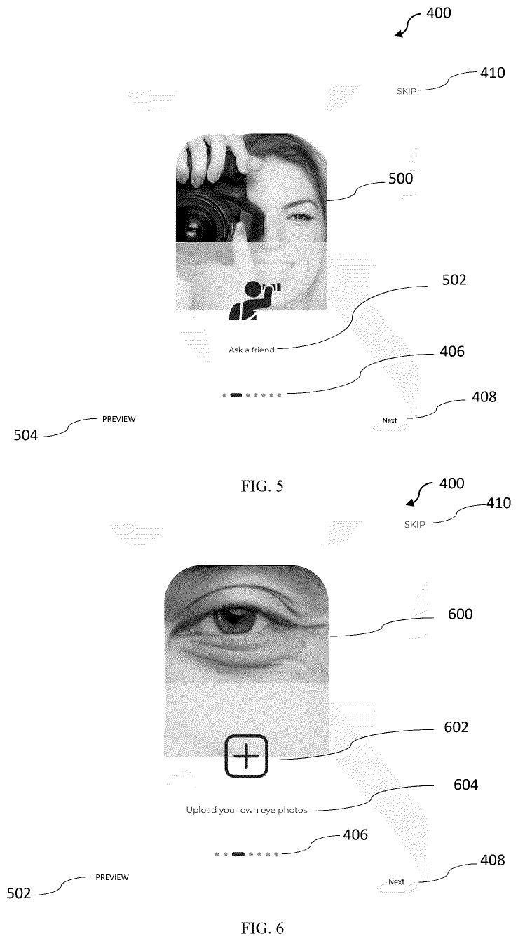

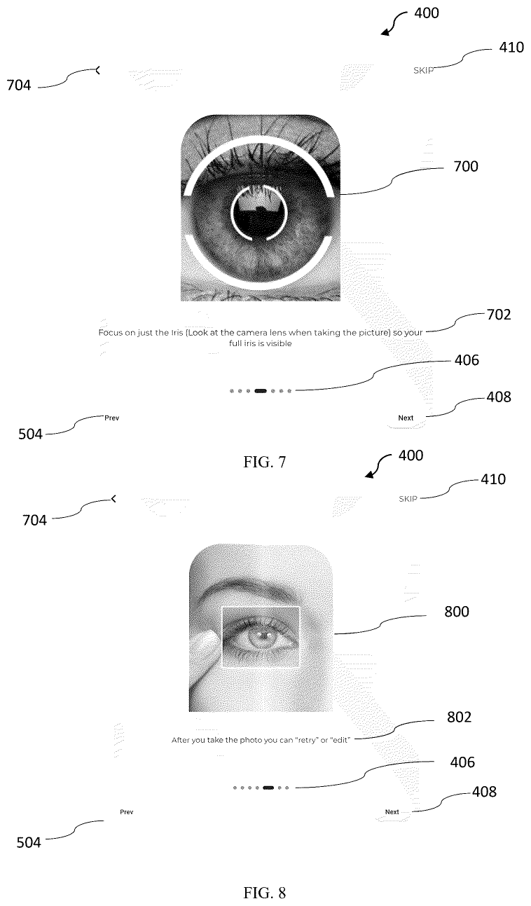

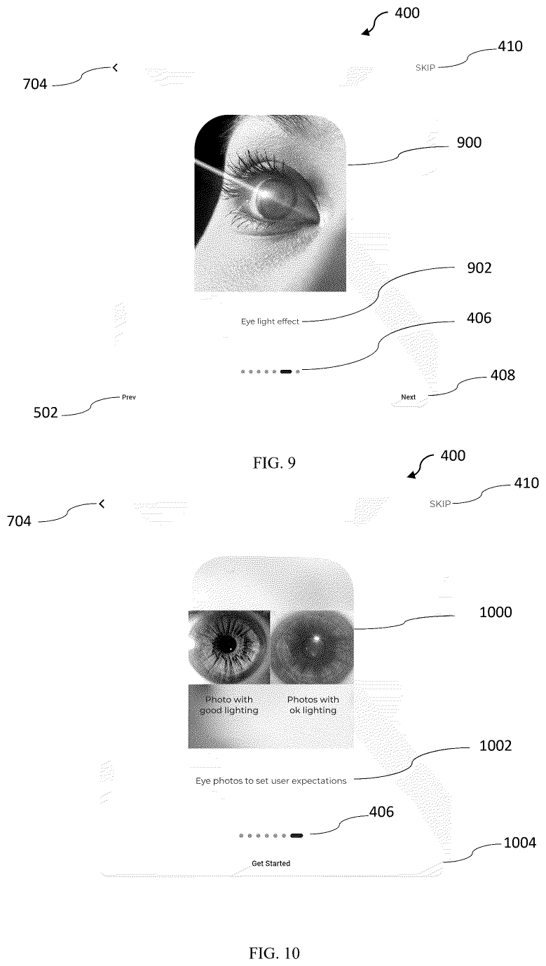

FIGS. 4-10 illustrate a user interface (UI) 400 depicting startup pages, according to an example embodiment of the present disclosure. FIGS. 4-10 are described in conjunction with FIGS. 1-3.

In some embodiments, the UI 400 may be operated by the user to determine the ancestral information using the AI technique. The UI 400 may be operated by the user using the user device 108. In some embodiments, the UI 400 may comprise startup pages. The startup pages may comprise an image icon 402 and represented by a text information. In one example, the UI 400 may have a first startup page having the image icon 402 showing a person taking a selfie by using a mobile phone. Further, the image icon 402 may be supported by an instruction-1 404 “Take your own eye photos”.

In some embodiments, the first startup page provides information to the user to capture one or more images of eyes using the user device 108. Further, below the instruction-1 404, a toggle bar 406 may be positioned. The toggle bar 406 may be used to allow the user to switch between different startup pages by swiping over the toggle bar 406. Further, the UI 400 may comprise a next button 408. The next button 408 may allow the user to jump onto the next startup page. Further, a skip button 410 may be positioned at a corner of the UI 400. The skip button 410 may be used to allow the user to skip from a current startup page to a next startup page.

Further, in the next startup page, an image icon 500 may represent capturing the one or more images with the help of another user. The image icon 500 may be supported by instruction-2 502 “Ask a friend”. Such startup page may be configured to allow the user to capture the one or more images using another image capturing device (not shown) of another user. In some embodiments, a left bottom corner of the UI 400 may comprise a preview button 504. The preview button 504 may enable the user to go back to the previous startup page.

Further, in the next startup page, an image icon 600 may represent to upload one or more images of the eyes of the user. In one example, the image icon 600 shows an image of an eye. Further, the UI 400 may comprise an add button 602. The add button 602 may be configured to allow the user to capture and upload the one or more images of the eye. Further, an instruction-3 604 “upload your own eye photos” may be provided to direct the user to upload the one or more images of the eyes of the user into the application (App) running on the user's mobile device.

Further, in the next startup page, an image icon 700 may represent to focus on the iris of the eyes of the user when capturing the one or more images. In one example, the image icon 700 shows the image of an eye of the user focused on the iris. Further, an instruction-4 702 “Focus on just the iris (Look at the camera lens when taking the picture) so your full iris is visible” may be displayed over the UI 400. As discussed earlier, the at least one processor 200 may be configured to extract the one or more characteristics from the iris of the eyes of the user, using the AI model 106. Further, the UI 400 may further comprise a back button 704 to allow the user to jump back to previous startup page.

Further, in the next startup page, an image icon 800 may represent to retry or edit the one or more images captured by the user. In one example, the image icon 800 shows the eye of the user focused on the eye. Further, an instruction-5 802 “After you take the photo you can “retry” of “edit”” may be displayed over the UI 400. In some embodiments, the UI 400 may be configured to allow the user to retake the one or more images captured by looking at a preview (not shown) or edit the one or more images, to provide clearer one or more images for determining the ancestral information of the user.

Further, in the next startup page, an image icon 900 may represent an effect or a presence of eye light in the one or more images. In one example, the image icon 900 shows the image of the eye of the user when a light reflection is present. Further, an instruction-6 902 “Eye light-effect” may be displayed over the UI 400. In some embodiments, the UI 400 may be configured to alert or provide a precaution the user about presence of the eye light in the one or more images of the eye or possibility of presence of the eye light while capturing the one or more images of the eyes by the user.

Further, in the next startup page, an image icon 1000 may represent example images of the eyes ideal scenarios and non-ideal scenarios for the user. In one example, the image icon 1000 shows an image of an eye having light reflection and shows another image of another eye captured with clarity and having minimal light reflection. Further, an instruction-7 1002 “Eye photos to set user expectations” may be displayed over the UI 400. In some embodiments, the UI 400 may be configured to provide a “get started button” 1004 for determining the ancestral information. In some embodiments, the UI 400 may be configured to provide the user with examples on which type of the one or more images may be uploaded for better results by the user.

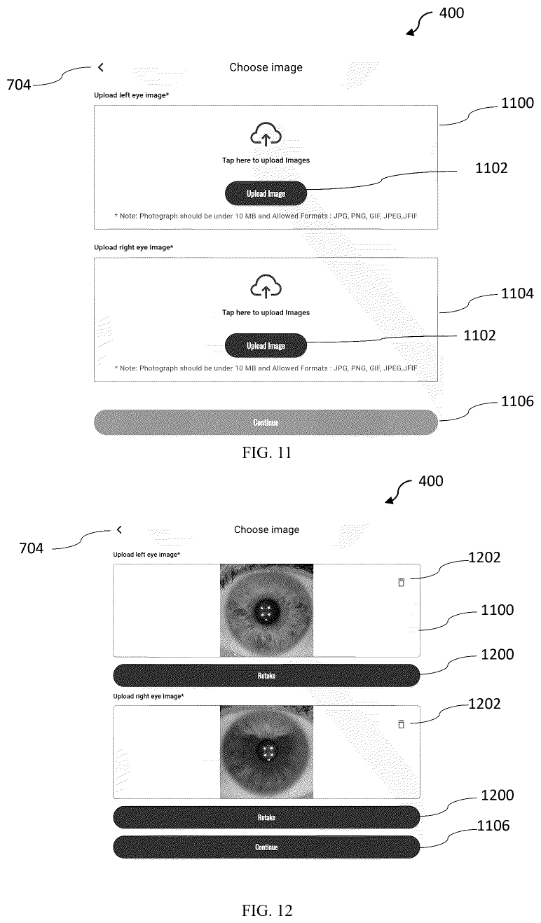

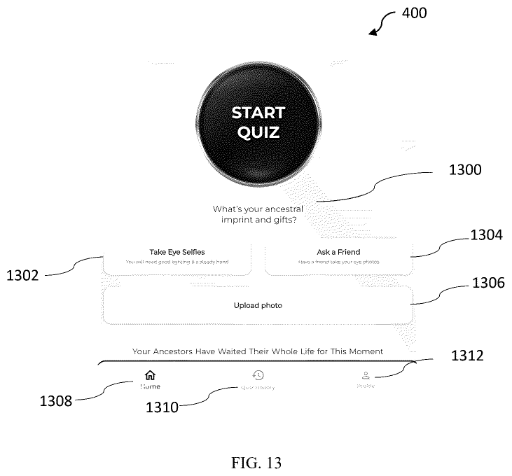

FIGS. 11-12 illustrate the UI 400 depicting image upload page, according to an example embodiment of the present disclosure. FIG. 13 illustrates the UI 400 depicting a quiz page, according to the example embodiment of the present disclosure. FIGS. 11-13 are described in conjunction with FIGS. 1-10.

In some embodiments, upon completing all the startup pages, the UI 400 may be configured to enable the user to upload one or more images of the left eye and the right eye on the application (App) running on the user device 108. The UI 400 may comprise a “upload left eye image” box 1100 and an “upload right eye image” box 1104. In some embodiments, the user may be configured to directly upload the one or more images saved within the gallery of the image capturing device or stored within the cloud. In some embodiments, the “upload left eye image” box 1100 and the “upload right eye image” box 1104 may comprise an upload image button 1102. The upload image button 1102 may be tapped by the user for choosing one or more images from the gallery. Further, a continue button 1106 may be provided to allow the user to go to a next page in the UI 400 upon successfully uploading the one or more images.

Further, in the next page, the UI 400 may be configured to enable the user to preview the one or more images uploaded by the user. In some embodiments, the “upload left eye image” box 1100 and the “upload right eye image” box 1104 may show the preview of the left eye image and the right eye image of the user, respectively. The user based on the previewed image may decide to retake or continue with the uploaded one or more images of the left eye and the right eye. In some embodiments, a retake button 1200 below the upload left eye image” box 1100 and the “upload right eye image” box 1104 may be provided to enable the user to remove current one or more images and retake another one or more images. Further, the UI 400 may comprise a delete button 1202. The delete button 1202 may enable the user to delete or remove the uploaded one or more images.

Further, in the next page, the UI 400 may be configured to display the one or more quiz questions generated by the at least one processor 200. The UI 400 may comprise a quiz question “What's your ancestral imprint and gifts” 1300. Further, the user may be provided with follow up messages “Take eye selfies” 1302 and “Ask a friend” 1304. In one instance, upon selecting “Take eye selfies” 1302, the at least one processor 200 may be configured to allow the user to capture own eye images. In another instance, upon selecting “Ask a friend” 1304, the UI 400 may direct the user to take one or more images and upload it using an upload photo button 1306. In another instance, upon selecting the upload photo button 1306, the UI 400 may direct the user to upload the one or more images of the eyes. Further, the UI 400 may comprise a home button 1308 to allow the user to jump to a home page (not shown). The home page may comprise one or more options for the user to login to the UI 400. Further, the UI 400 may comprise a quiz history button 1310 that displays previous quiz questions asked to the user. Further, the UI 400 may comprise a profile button 1312 to enable the user to visit profile page of the user. The profile page may comprise one or more details of the user including name, gender, etc.

It will be apparent to one skilled in the art that above-mentioned UI 400 and its features have been provided only for illustration purposes, without departing from the scope of the disclosure.

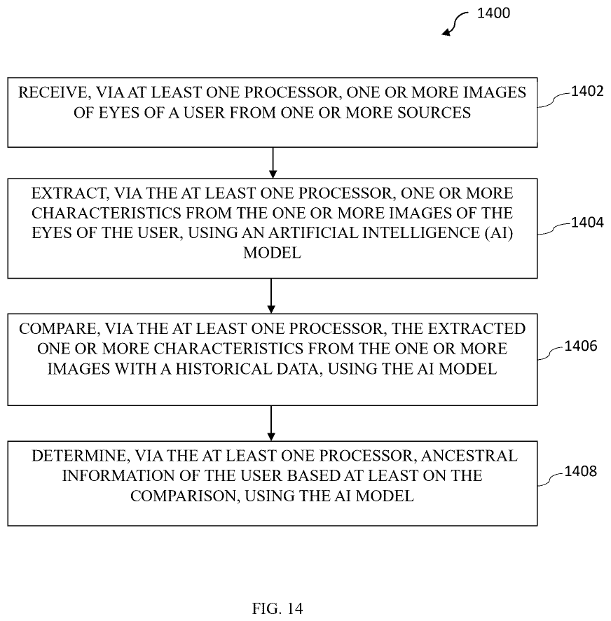

FIG. 14 illustrates a flowchart 1400 showing a method for determining the ancestral information of the user using the AI technique, according to the example embodiment of the present disclosure. FIG. 14 is described in conjunction with FIGS. 1-13.

At step 1402, the at least one processor 200 is configured to receive one or more images of eyes of the user from one or more sources. The one or more sources comprises at least one of an image capturing device that is configured to capture the one or more images of the eyes of the user. For example, the image capturing device may be mobile phones and digital cameras etc. Further, the one or more images may correspond to a left eye image and a right eye image of the user.

At step 1404, the at least one processor 200 is configured to extract one or more characteristics from the one or more images of the eyes of the user, using the AI model 106. In some embodiments, the one or more characteristics correspond to distinct and identifiable features that describe structure, function, and appearance of the left eye and the right eye of the user. In some embodiments, the one or more characteristics comprises at least one of color of the left eye and the right eye, color of iris of the left eye and the right eye, autonomic nerve wreath (ANW), pupil size, sclera, achievement rings, or iris patterns.

At step 1406, the at least one processor 200 is configured to compare the extracted one or more characteristics from the one or more images with a historical data, using the AI model 106. In some embodiments, the historical data corresponds to a repository of one or more sample images of eyes of users having the one or more characteristics collected over a predefined time period. In some embodiments, the predefined time period corresponds to hours, days, months, or years.

At step 1408, the at least one processor 200 is configured to determine ancestral information of the user based at least on the comparison between the extracted one or more characteristics from the one or more images with the historical data, using the AI model 106. The ancestral information corresponds to data and knowledge related to predecessors or originators of the user. In some embodiments, the ancestral information comprises at least one of basis of origin of the user, brain hemisphere orientation, one or more indicators of personality shifts within the user, vocational gifts, or ancestral images. The one or more indicators of personality shifts within the user correspond to one or more features of the eyes that are responsible for determining at least one of emotional, physical, and psychological state of the user. In some embodiments, the one or more indicators comprises at least one of postage stamps, cross fiber, channels, fiber separation, or freckle.

In some embodiments, the at least one processor 200 may be configured to identify one or more aberrations associated with the user, based at least on the determined ancestral information, using the AI model 106. In some embodiments, the one or more aberrations comprise at least one of unresolved traumas, energetic and operating process of the user, and a way of interaction of the user with other users. In some embodiments, the at least one processor 200 is configured to train the AI model 106 based at least on the repository of the one or more sample images of the eyes of the users for determining the ancestral information of the user.

In some embodiments, the at least one processor 200 may further be configured to generate one or more quiz questions using the AI model 106, to determine an intuitive type of the user. The intuitive type corresponds to an attribute of the user, where the user relies on intuition during a decision-making process. In some embodiments, the at least one processor 200 is configured to display the determined ancestral information of the user and the one or more aberrations to the user, using the user device 108.

In some embodiments, the at least one processor 200 may be configured to create one or more overlay regions of the eyes of the user, using the AI model 106. The one or more overlay regions of the eyes of the user correspond to one or more regions of iris, pupil, rings, or sclera. Further, the at least one processor 200 may be configured to receive selection of at least one overlay region from the one or more overlay regions, from the user, to determine the ancestral information associated to the selected at least one overlay region of the user.

In another example embodiment, a non-transitory machine-readable information storage medium is disclosed. The non-transitory machine-readable information storage medium comprises one or more instructions which when executed by at least one processor 200 cause the at least one processor 200 to receive one or more images of eyes of a user from one or more sources, wherein the one or more images correspond to a left eye image and a right eye image of the user; extract one or more characteristics from the one or more images of the eyes of the user, using an artificial intelligence (AI) model, wherein the one or more characteristics correspond to distinct and identifiable features that describe structure, function, and appearance of the left eye and the right eye of the user; compare the extracted one or more characteristics from the one or more images with a historical data, using the AI model 106; and determine ancestral information of the user based at least on the comparison, using the AI model 106, wherein the ancestral information corresponds to data and knowledge related to predecessors or originators of the user.

It will be apparent to one skilled in the art that embodiments of the present disclosure relate to the method and the system 100 that, upon when executed is configured to determine ancestral information of the user using the AI technique, without departing from the scope of the disclosure.

While there is shown and described herein certain specific structures embodying various embodiments of the disclosure, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

### LIST OF ELEMENTS

100—System
102—Network
104—Server
106—Artificial intelligence (AI) model
200—At least one processor
202—Memory
204—Input/output circuitry
206—Communication circuitry
300—Table
302—User ID
304—Left eye
306—Left eye characteristics
308—Right eye
310—Right eye characteristics
312—Depiction of the right eye characteristics
314—Result of the right eye characteristics
400—User interface (UI)
402—Image icon
404—Instruction-1
406—Toggle bar
408—Next button
410—Skip button
500—Image icon
502—Instruction-2
504—Preview button
600—Image icon
602—Add button
604—Instruction-3
700—Image icon
702—Instruction-4
704—Back button
800—Image icon
802—Instruction-5
900—Image icon
902—Instruction-6
1000—Image icon
1002—Instruction-7
1004—Get Started button
1100—Upload left eye image box
1102—Upload image button
1104—Upload right eye image box
1106—Continue button
1200—Retake button
1202—Delete button
1300—Quiz question
1302—Take eye selfies
1304—Ask a friend
1306—Upload photo button
1308—Home button
1310—Quiz history button
1312—Profile button
1400—Flowchart
1402—Step
1404—Step
1406—Step
1408—Step

What is claimed is:

1. A method comprising:
receiving, via at least one processor, one or more images of eyes of a user from one or more sources, wherein the one or more images correspond to a left eye image and a right eye image of the user;
extracting, via the at least one processor, one or more characteristics from the one or more images of the eyes of the user, using an artificial intelligence (AI) model, wherein the one or more characteristics correspond to distinct and identifiable features that describe structure, function, and appearance of the left eye and the right eye of the user;
comparing, via the at least one processor, the extracted one or more characteristics from the one or more images with a historical data, using the AI model; and
determining, via the at least one processor, ancestral information of the user based at least on the comparison, using the AI model, wherein the ancestral information corresponds to data and knowledge related to predecessors or originators of the user.

2. The method of claim 1 further comprising identifying, via the at least one processor, one or more aberrations associated with the user, based at least on the determined ancestral information, using the AI model, and wherein the one or more aberrations comprise at least one of unresolved traumas, energetic and operating process of the user, and a way of interaction of the user with other users.

3. The method of claim 1, wherein the ancestral information comprises at least one of basis of origin of the user, brain hemisphere orientation, one or more indicators of personality shifts within the user, vocational gifts, or ancestral images, and wherein the one or more indicators of personality shifts within the user correspond to one or more features of the eyes that are responsible for determining at least one of emotional, physical, and psychological state of the user, and wherein the one or more indicators comprise at least one of postage stamps, cross fiber, channels, fiber separation, or freckle.

4. The method of claim 1, wherein the historical data corresponds to a repository of one or more sample images of eyes of users having the one or more characteristics collected over a predefined time period, and wherein the predefined time period corresponds to hours, days, months, or years.

5. The method of claim 4 further comprising training, via the at least one processor, the AI model based at least on the repository of the one or more sample images of the eyes of the users for determining the ancestral information of the user.

6. The method of claim 1 further comprising generating, via the at least one processor, one or more quiz questions using the AI model, to determine an intuitive type of the user, wherein the intuitive type corresponds to an attribute of the user, where the user relies on intuition during a decision-making process.

7. The method of claim 1 further comprising:
creating, via the at least one processor, one or more overlay regions of the eyes of the user, using the AI model, wherein the one or more overlay regions of the eyes of the user correspond to one or more regions of iris, pupil, rings, or sclera; and
receiving, via the at least one processor, a selection of at least one overlay region from the one or more overlay regions, from the user, to determine the ancestral information associated to the selected at least one overlay region of the user.

8. The method of claim 1, wherein the one or more characteristics comprise at least one of color of the left eye and the right eye, color of iris of the left eye and the right eye, autonomic nerve wreath (ANW), pupil size, sclera, achievement rings, or iris patterns.

9. The method of claim 2 further comprising displaying, via the at least one processor, the determined ancestral information of the user and the one or more aberrations, to the user.

10. The method of claim 1, wherein the one or more sources comprise at least one of an image capturing device that is configured to capture the one or more images of the eyes of the user.

11. A system comprising:
a memory; and
at least one processor communicatively coupled to the memory, wherein the at least one processor is configured to:
receive one or more images of eyes of a user from one or more sources, wherein the one or more images correspond to a left eye image and a right eye image of the user;
extract one or more characteristics from the one or more images of the eyes of the user, using an artificial intelligence (AI) model, wherein the one or more characteristics correspond to distinct and identifiable features that describe structure, function, and appearance of the left eye and the right eye of the user;
compare the extracted one or more characteristics from the one or more images with a historical data, using the AI model; and
determine ancestral information of the user based at least on the comparison, using the AI model, wherein the ancestral information corresponds to data and knowledge related to predecessors or originators of the user.

12. The system of claim 11, wherein the at least one processor is configured to identify one or more aberrations associated with the user, based at least on the determined ancestral information, using the AI model, and wherein the one or more aberrations comprise at least one of unresolved traumas, energetic and operating process of the user, and a way of interaction of the user with other users.

13. The system of claim 11, wherein the ancestral information comprises at least one of basis of origin of the user, brain hemisphere orientation, one or more indicators of personality shifts within the user, vocational gifts, or ancestral images, and wherein the one or more indicators of personality shifts within the user correspond to one or more features of the eyes that are responsible for determining at least one of emotional, physical, and psychological state of the user, and wherein the one or more indicators comprises at least one of postage stamps, cross fiber, channels, fiber separation, or freckle.

14. The system of claim 11, wherein the historical data corresponds to a repository of one or more sample images of eyes of users having the one or more characteristics collected over a predefined time period, and wherein the predefined time period corresponds to hours, days, months, or years, and wherein the one or more characteristics comprises at least one of color of the left eye and the right eye, color of iris of the left eye and the right eye, autonomic nerve wreath (ANW), pupil size, sclera, achievement rings, or iris patterns.

15. The system of claim 14, wherein the at least one processor is configured to train the AI model based at least on the repository of the one or more sample images of the eyes of the users for determining the ancestral information of the user.

16. The system of claim 11, wherein the at least one processor is configured to generate one or more quiz questions using the AI model, to determine an intuitive type of the user, wherein the intuitive type corresponds to an attribute of the user, where the user relies on intuition during a decision-making process.

17. The system of claim 11, wherein the at least one processor is configured to:
create one or more overlay regions of the eyes of the user, using the AI model, wherein the one or more overlay regions of the eyes of the user correspond to one or more regions of iris, pupil, rings, or sclera; and
receive a selection of at least one overlay region from the one or more overlay regions, from the user, to determine the ancestral information associated to the selected at least one overlay region of the user.

18. A non-transitory machine-readable information storage medium comprising one or more instructions which when executed by at least one processor cause the at least one processor to:
receive one or more images of eyes of a user from one or more sources, wherein the one or more images correspond to a left eye image and a right eye image of the user;
extract one or more characteristics from the one or more images of the eyes of the user, using an artificial intelligence (AI) model, wherein the one or more characteristics correspond to distinct and identifiable features that describe structure, function, and appearance of the left eye and the right eye of the user;
compare the extracted one or more characteristics from the one or more images with a historical data, using the AI model; and
determine ancestral information of the user based at least on the comparison, using the AI model, wherein the ancestral information corresponds to data and knowledge related to predecessors or originators of the user.

19. The non-transitory machine-readable information storage medium of claim 18, wherein the at least one processor is configured to identify one or more aberrations associated with the user, based at least on the determined ancestral information, using the AI model, and wherein the one or more aberrations comprise at least one of unresolved traumas, energetic and operating process of the user, and a way of interaction of the user with other users.

20. The non-transitory machine-readable information storage medium of claim 18, wherein the one or more characteristics comprises at least one of color of the left eye and the right eye, color of iris of the left eye and the right eye, autonomic nerve wreath (ANW), pupil size, sclera, achievement rings, or iris patterns, and wherein the ancestral information comprises at least one of basis of origin of the user, brain hemisphere orientation, one or more indicators of personality shifts within the user, vocational gifts, or ancestral images, and wherein the one or more indicators of personality shifts within the user correspond to one or more features of the eyes that are responsible for determining at least one of emotional, physical, and psychological state of the user, and wherein the one or more indicators comprises at least one of postage stamps, cross fiber, channels, fiber separation, or freckle.
